(19) United States
(12) Patent Application Publication
(10) Pub. No.: US 2025/0121595 A1
(43) Pub. Date: Apr. 17, 2025

(54) ACTUATOR, LIQUID EJECTION HEAD, AND LIQUID EJECTION APPARATUS

(71) Applicant: CANON KABUSHIKI KAISHA, Tokyo (JP)

(72) Inventors: SHUJI TOBASHI, Kanagawa (JP); TAKASHI IKEDA, Kanagawa (JP)

(21) Appl. No.: 18/909,775

(22) Filed: Oct. 8, 2024

(30) Foreign Application Priority Data
Oct. 12, 2023 (JP) 2023-176937

(51) Int. Cl. B41J 2/14; B41J 2/16

(52) U.S. Cl. CPC B41J 2/14233; B41J 2/161; B41J 2/1626; B41J 2/1631; B41J 2/1646; B41J 2002/14491

(57) ABSTRACT

An actuator for a liquid ejection head includes an electrode which is disposed on a substrate; a piezoelectric film which is configured to be displaced by application of voltage from the electrode; a wiring which is electrically connected to the electrode; a first insulating film, which is disposed to be interposed between the electrode and the wiring, and which has a through hole for electrically connecting the electrode and the wiring; and a second insulating film which covers the wiring. The through hole has a planar shape including a curved portion, in a view in a thickness direction of the substrate, and a radius of curvature of the curved portion is at least 8 times a film thickness of the first insulating film.

### BACKGROUND

### Field

The present disclosure relates to an actuator, a liquid ejection head, and a liquid ejection apparatus.

### Description of the Related Art

A piezoelectric material, of which form is changed when an electric field is applied, is used for various industrial products, as means for moving or vibrating an object microscopically and accurately. For example, the piezoelectric material is used for a small-sized speaker, a hard disk drive, and a liquid ejection apparatus including a printer (image recording apparatus). In some printers, a piezoelectric film is used for a liquid ejection head to eject droplets. In such a liquid ejection head, an electric field is applied by electrodes (upper electrode, lower electrode), which are formed to sandwich the piezoelectric film from top and bottom, whereby the piezoelectric film is driven to eject droplets. With several tens of voltage being needed to sufficiently displace the piezoelectric film, here as a semiconductor device, it is preferable to apply a relatively high voltage. On the other hand, the liquid ejection head is miniaturized to print high resolution images, and wirings and electrodes, of which potentials are different, are disposed at high density.

Due to the above conditions, in the liquid ejection head, electric current may flow through the device surface and cause malfunction. Therefore, wirings and electrodes formed on the device surface need to be covered by a passivation film having insulation properties (e.g., Japanese Patent Application Publication No. 2012-196838).

Some liquid ejection heads have a structure where the upper electrode and the lower electrode, sandwiching the piezoelectric film, are electrically connected to an upper wiring and a lower wiring respectively via a through hole, which is formed in a part of an insulating film covering the upper electrode and lower electrode. In this structure, a step part, due to the through hole formed in the insulation film, is covered by wiring, and insulating passivation film formed thereon also conforms to this step difference. In the case of forming this structure on the piezoelectric film, the through hole is formed as narrow as possible in the longitudinal direction of the piezoelectric film so as to efficiently displace the piezoelectric film, and is formed as wide as possible in the width direction of the piezoelectric film so as to implement favorable electric connection, hence the through hole becomes rectangular. In the case of the lower electrode, a rectangular through hole is formed, similarly to the upper electrode, so as to minimize the surface area occupied by this structure.

However a problem of a passivation film covering a rectangular through hole is that the coverage of the film tends to be insufficient at the corners of the through hole, and the device may malfunction due to a short circuit when high voltage is applied to drive the piezoelectric film.

### SUMMARY

With the foregoing in view, the present disclosure advantageously provides an actuator which excels in durability.

According to some embodiments, an actuator for a liquid ejection head includes:
an electrode which is disposed on a substrate;
a piezoelectric film which is configured to be displaced by application of voltage from the electrode;
a wiring which is electrically connected to the electrode;
a first insulating film, which is disposed to be interposed between the electrode and the wiring, and which has a through hole for electrically connecting the electrode and the wiring; and
a second insulating film which covers the wiring,
wherein the through hole has a planar shape including a curved portion, in a view in a thickness direction of the substrate, and
wherein a radius of curvature of the curved portion is at least 8 times a film thickness of the first insulating film.

According to some embodiments, a liquid ejection head includes:
an actuator including:
   an electrode which is disposed on a substrate;
   a piezoelectric film which is configured to be displaced by application of voltage from the electrode;
   a wiring which is electrically connected to the electrode,
   a first insulating film, which is disposed to be interposed between the electrode and the wiring, and which has a through hole for electrically connecting the electrode and the wiring; and
   a second insulating film which covers the wiring,
   wherein the through hole has a planar shape including a curved portion, in a view in a thickness direction of the substrate,
   wherein a radius of curvature of the curved portion is at least 8 times a film thickness of the first insulating film, and
wherein the liquid ejection head is configured to eject liquid.

According to some embodiments, a liquid ejection apparatus includes:
a liquid ejection head includes an actuator and is configured to eject liquid,
   the actuator including:
      an electrode which is disposed on a substrate;
      a piezoelectric film which is configured to be displaced by application of voltage from the electrode;
      a wiring which is electrically connected to the electrode;
      a first insulating film, which is disposed to be interposed between the electrode and the wiring, and which has a through hole for electrically connecting the electrode and the wiring; and
      a second insulating film which covers the wiring,
      wherein the through hole has a planar shape including a curved portion, in a view in a thickness direction of the substrate, and
      wherein a radius of curvature of the curved portion is at least 8 times a film thickness of the first insulating film.

According to the present disclosure, an actuator which rarely malfunctions even under a highly humid environment and excels in durability, or a liquid ejection head using this actuator, can be provided.

Further features of the present disclosure will become apparent from the following description of exemplary embodiments with reference to the attached drawings.

### BRIEF DESCRIPTION OF THE DRAWINGS

FIG. 1 is a conceptual cross-sectional view for describing a structure of an example of an actuator of the present disclosure.

FIG. 2 is a schematic diagram for describing a planar shape of a through hole of the actuator of the present disclosure.

FIGS. 3A to 3D are conceptual cross-sectional views of a method of manufacturing an actuator according to Example 1.

FIGS. 4A and 4B are schematic diagrams for describing a planar shape of a through hole of Example 1.

FIGS. 5A to 5C are conceptual cross-sectional views in the method of manufacturing the actuator according to Example 1.

FIGS. 6A to 6D are conceptual cross-sectional views in a method of manufacturing an actuator according to Example 2.

FIGS. 7A and 7B are schematic diagrams for describing a planar shape of a through hole of Example 2.

FIGS. 8A to 8C are conceptual cross-sectional views in the method of manufacturing the actuator according to Example 2.

FIGS. 9A to 9D are conceptual cross-sectional views in a method of manufacturing an actuator according to Example 3.

FIGS. 10A and 10B are schematic diagrams for describing a planar shape of a through hole of Example 3.

FIGS. 11A to 11C are conceptual cross-sectional views in the method of manufacturing the actuator according to Example 3.

### DESCRIPTION OF THE EMBODIMENTS

Various exemplary embodiments, features, and aspects of the present disclosure will now be described based on examples with reference to the drawings. Dimensions, materials, and shapes of components, relative positions thereof, and the like described in the embodiments may be appropriately changed depending on the configuration and various conditions of the apparatus to which the present disclosure is applied. Further, not all of the combinations of the features described in the embodiments are essential for the solution to a problem by the present disclosure. Composing elements described in the embodiments are mere examples, and are not intended to limit the scope of the disclosure to this description.

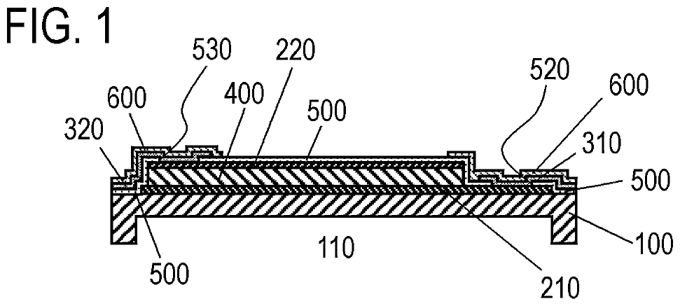

As illustrated in FIG. 1, an actuator, which is a micro-structure fabricated using a semiconductor process of the present disclosure, is an actuator for a liquid ejection head in the present embodiment. In a thickness direction of a substrate 100, a lower electrode (first electrode) 210 is disposed on the substrate 100, and an upper electrode (second electrode) 220 is disposed on the opposite side of the lower electrode 210 in the longitudinal direction of a piezoelectric film 400, such as to sandwich the piezoelectric film 400 with the lower electrode 210. In the liquid ejection head, a concave portion 110 is formed on a rear surface of the surface on which the actuator of the substrate 100 is disposed, and the piezoelectric film 400 is disposed so as to overlap with this concave portion 110. The concave portion 110 is a liquid chamber, and when the actuator is driven, liquid is ejected from an ejection port (not illustrated) which fluidly communicates with the liquid chamber. If a combination of the ejection port, the actuator and the pressure chamber is regarded as one ejection element, a plurality of ejection elements is arrayed in the Y direction at a 150 npi (nozzle per inch) density, for example, in the liquid ejection head of the present embodiment. The density of disposing the ejection elements is not limited to this, and may be higher (e.g. 300 npi) or lower than this density.

The substrate 100 is preferable to have a flat surface, and a suitable material thereof may be selected from silicon, silicon carbide, quartz, gallium nitride, gallium arsenide, indium phosphide, sapphire, and the like, for example. Further, a silicon-on-insulator (SOI) wafer may be used in order to easily form the concave portion 110. The SOI wafer is formed by forming a silicon oxide layer (BOX layer) on a silicon substrate, and forming a silicon layer thereon. The BOX layer can be formed in a range of several tens nm (nanometers) to several hundreds μm (micrometers) thickness, and the film thickness of the silicon layer thereon can also be selected relatively freely. These film thicknesses may appropriately be combined, and by performing selective etching using the BOX layer as an etching stop layer, only silicon can be removed. The bottom surface of the concave portion formed by such etching is the surface of the BOX layer, therefore a very flat bottom surface can be obtained.

The lower electrode 210 disposed on the substrate may be exposed to a high temperature, several hundred ° C. (Celsius), in subsequent processes, and in such a case is preferably formed of a material having a high melting temperature. Possible materials that may be used here are, for example, copper, platinum, gold, chromium, cobalt and titanium, or an alloy thereof. In the case of forming the piezoelectric film 400 contacting with the upper surface of the lower electrode 210, in the thickness direction of the substrate 100, the lower electrode 210 may play the role of a film to control the crystal orientation of the piezoelectric film. In this case, a material having an appropriate crystal structure is selected. For example, if the material of the piezoelectric film 400 is lead zirconate titanate, it is preferable to user platinum for the crystal orientation control film. For the film deposition of platinum, a commonly used film deposition method, such as magnetron sputtering, can be used, and the film thickness is appropriately adjusted so that a desired crystal orientation can be obtained.

Further, in the lower electrode 210, a thin film of titanium, chromium, or the like is disposed as an adhesion layer (not illustrated), in order to acquire an adhesive force with the substrate 100. This adhesion layer may be a laminated film with a conductive layer (not illustrated) which is formed of any one of the above mentioned materials and a material commonly used for wiring. As mentioned above, if the piezoelectric film 400 is formed contacting with the conductive layer, a material having an appropriate crystal structure is selected for the conductive layer. In a case where the substrate 100 has conductivity, it is preferable to disposed an insulating film 510 (not illustrated) between the lower electrode 210 and the substrate 100. For the insulating film 510, a commonly used insulating material, such as silica, silicon nitride, oxynitride and alumina, can be used.

An insulating film (first insulating film) 500 is formed between the lower electrode 210 and a lower wiring (first wiring) 310, which is disposed on one side of the piezoelectric film 400 in the longitudinal direction, and between the lower electrode 210 and the piezoelectric film 400 respectively. An insulating film 500 is further formed between an upper wiring (second wiring) 320, which is disposed on the other side of the piezoelectric film 400 in the longitudinal direction, and the upper electrode 220, and between the upper electrode 220 and the piezoelectric film 400 respectively. A material used for the insulating film 500 can be selected from commonly used insulating materials for the insulating film 510, as mentioned above, such as silica, silicon nitride, oxynitride, alumina and the like. Further, a laminated film, constituted of two or more types of elements selected from these materials, may be used. An alloy film thereof may also be used. In order to displace the piezoelectric film 400 as a semiconductor device, a relatively large potential difference is applied between the upper electrode 220 or upper wiring 320 and the lower electrode 210 or lower wiring 310. In order to displace the piezoelectric film 400 sufficiently, the potential difference applied to the piezoelectric film 400 in the film thickness direction is preferably at least 30V (volts).

On the other hand, since the breakdown field strength of the insulating film is about 10 MV/cm (volts/centimeter), failure probability can be reduced if the film thickness of the insulating film 500 is at least 30 nm. For a film deposition method to deposit the insulating film having such a film thickness with favorable productivity, a chemical vapor deposition (CVD) method or a spluttering method is normally used.

In order to displace the piezoelectric film 400 by applying a desired voltage to the lower electrode 210 and the upper electrode 220, the lower wiring 310 is electrically connected to the lower electrode 210, and the upper wiring 320 is electrically connected to the upper electrode 220. For this, a lower through hole (first through hole) 520 and an upper through hole (second through hole) 530 are formed in the insulating film 500.

After forming the through holes 520 and 530, the lower wiring 310 and the upper wiring 320 are formed. For these wirings, commonly used materials can be used, such as aluminum, copper and gold, or an alloy thereof. In order to improve the adhesion of the wirings, it is preferable to insert a titanium film or chromium film between the insulating film 500 and the lower wiring 310, or between the insulating film 500 and the upper wiring 320.

As mentioned above, a relatively high voltage is applied to sufficiently displace the piezoelectric film 400 disposed on the actuator, and the surface density of the structures on the chip is high, hence under a highly humid environment, current may flow through the surface of the device, and may cause malfunction. To prevent this, it is preferable to cover the upper wiring 320 and the lower wiring 310 with a passivation film 600 having high insulating properties as a second insulating film. Materials that can be suitably used for the passivation film 600 are silica, silicon nitride, alumina and the like, having high insulating properties.

The actuator cannot be backfilled by an insulating film or the like, and the wirings formed thereon cannot be planarized using a chemical mechanical polishing (CMP) method or the like, because displacement of the actuator is diminished. Hence the step difference shapes generated by the upper through hole 530 and the lower through hole 520 are reflected to the surface shapes of the upper wiring 320 and the lower wiring 310. In other words, the passivation film 600 preferably covers at least a 30 nm step difference.

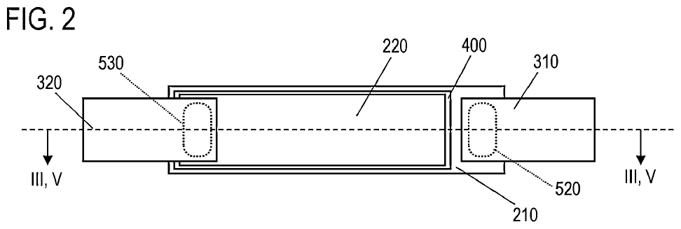

In the liquid ejection head fabricated using the semiconductor process, structures are formed at a high surface density, and the upper through hole 530 is formed with a minimum width in the longitudinal direction of the piezoelectric film 400, so that displacement of the piezoelectric film 400 is not interfered with. Further, in terms of production efficiency, it is preferable that the structures formed on the chip are disposed at high surface density, and the lower through hole 520 as well is formed with a minimum width in the longitudinal direction of the piezoelectric film 400. Furthermore, in order to make the electric connection between the wirings and the electrodes better, a through hole having a length about the same as the width of the piezoelectric film 400 in the lateral direction is formed. For these reasons, a rectangular shape has been conventionally adopted as the shape of the through hole in plan view. In the case of the rectangular shape, however, the coverage on the corners of the rectangle is diminished when the passivation film is formed, which makes it difficult to prevent current from flowing through the device surface. As a result of intensive studies to solve this problem, it was found that the through hole to connect the electrode and wiring preferably has a shape of rounded corners in a planar shape viewed in the thickness direction of the substrate 100, that is, it is preferable to round the corners of the rectangular shape. FIG. 2 is a schematic diagram for describing the planar shape of the through hole of the actuator of the present disclosure, and is a plan view viewed in a direction vertical to the surface of the substrate 100. In FIG. 2, the passivation film 600 indicated in FIG. 1 is omitted. The positions of the through holes 520 and 530 are indicated by dotted lines. It was discovered that the degree of rounding the corners (corner portions) of each through hole depends on the depth of the through hole, that is, the film thickness of the insulating film 500 in which the through hole is formed, and malfunction of the device can be prevented if the radius of curvature of each corner portion is at least 8 times the film thickness of the insulating film 500. In other words, in the thickness direction of the substrate 100, the radius of curvature of the curved portion of the through hole in the planar shape is preferably at least 8 times the film thickness of the first insulating film 500. In the present embodiment, the planar shape of the through hole is a rounded rectangle, of which corners are rounded, but the planar shape of the through hole is not limited to this, and only preferably include the curved portions viewed in the thickness direction of the substrate 100, and may be an elliptical shape or the like. Further, in the planar shape of the through hole, it is preferable that the radius of curvature of the curved portion is at least 8 times the film thickness of the first insulating film 500. As mentioned above, the film thickness of the insulating film 500 is preferably at least 30 nm, therefore the radius of curvature of the corner portions is preferably at least 240 nm. Hence an opening width of unrounded portions of the upper through hole 530 and the lower through hole 520 is at least 480 nm, even in the narrowest portion. Furthermore, as mentioned above, the opening width of the upper through hole 530 or the lower through hole 520 in the longitudinal direction of the piezoelectric film 400 (that is, the lateral direction of the rounded rectangle forming the through hole in FIG. 2) is wider than the width of the rounded portion, that is, at least 2 times the radius of curvature, in order to increase the surface density of the structure, as mentioned above. Moreover, the through hole is preferably formed linearly symmetrical with respect to the center line passing through the center of the piezoelectric film 400 in the lateral direction, so that voltage is evenly applied to the piezoelectric film 400, and the piezoelectric film 400 is efficiently displaced (See FIG. 2).

The piezoelectric film 400 is formed on the lower electrode 210. For the piezoelectric film 400, lead zirconate titanate is mainly used since a large displacement amount can be more easily obtained, but other piezoelectric materials, such as barium titanate, lead titanate, lead meta-niobate, bismuth titanate, zinc oxide, aluminum nitride, and potassium sodium niobate, may be used.

For the deposition of the piezoelectric film 400, a commonly used film disposition method, such as magnetron sputtering and coating (e.g. spin coat), may be used. The film thickness is preferably about 2 μm, and in the case of using the coating method, the film is deposited by coating a few layers at a time. The crystal orientation is aligned by baking after the coating. The baking temperature is selected to be suitable for the material, and may be in the 600° C. to 900° C. range in the case of lead zirconate titanate.

The upper electrode 220 disposed on the substrate is formed of a material having conductivity, and the material may be a material commonly used as an electrode material, such as aluminum, copper, tungsten, titanium, chromium, gold and platinum, for example. In a case where the internal stress of the lower electrode 210 and the like is large, and the piezoelectric film 400 is bent thereby, a reverse of the internal stress may be applied to the upper electrode 220, so that the stress on the entire device can be offset. A material appropriate for this purpose is an alloy of titanium and tungsten, for example.

### Example 1

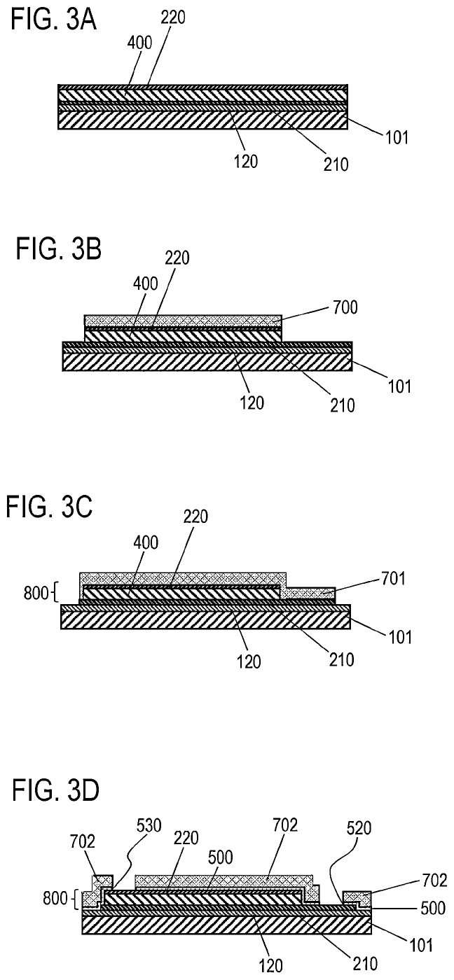

Example 1 will be described with reference to the drawings. FIGS. 3A to 5C are schematic diagrams of an example of an actuator and a manufacturing method thereof according to Example 1. As illustrated in FIG. 3A, a substrate 101 formed of silicon monocrystals is provided, and about a silicon oxide film of about a 2 μm silicon thickness is formed by a wet oxidation method, which forms the silicon oxide film using O₂ and H₂ gas, and an insulating film 120 is formed thereby.

Then the lower electrode 210 is formed by the sputtering method, and the piezoelectric film 400 is formed by the sol-gel method, and is then baked at 600° C. to have a desired crystal orientation, and the upper electrode 220 is formed by the sputtering method.

Then, as illustrated in FIG. 3B, a resist pattern 700 is formed by a photolithography method, such that the upper electrode 220 and the piezoelectric film 400 have desired patterns, and thereafter the upper electrode 220 and the piezoelectric film 400 are etched.

Then, as illustrated in FIG. 3C, a resist pattern 701 is formed by the photolithography method again, such that the lower electrode 210 has a desired pattern, and thereafter the lower electrode 210 is etched, and an actuator 800, constituted of the lower electrode 210, the piezoelectric film 400 and the upper electrode 220, is formed.

Then, as illustrated in FIG. 3D, an insulating film 500 of a 100 nm thickness is formed on the actuator 800 by the CVD method. Then a resist pattern 702 is formed on the insulating film 500 to have a predetermined pattern by the photolithography method, so that a through hole is formed in the upper electrode 220 and the lower electrode 210, and thereafter the upper through hole 530 and the lower through hole 520 are formed by etching.

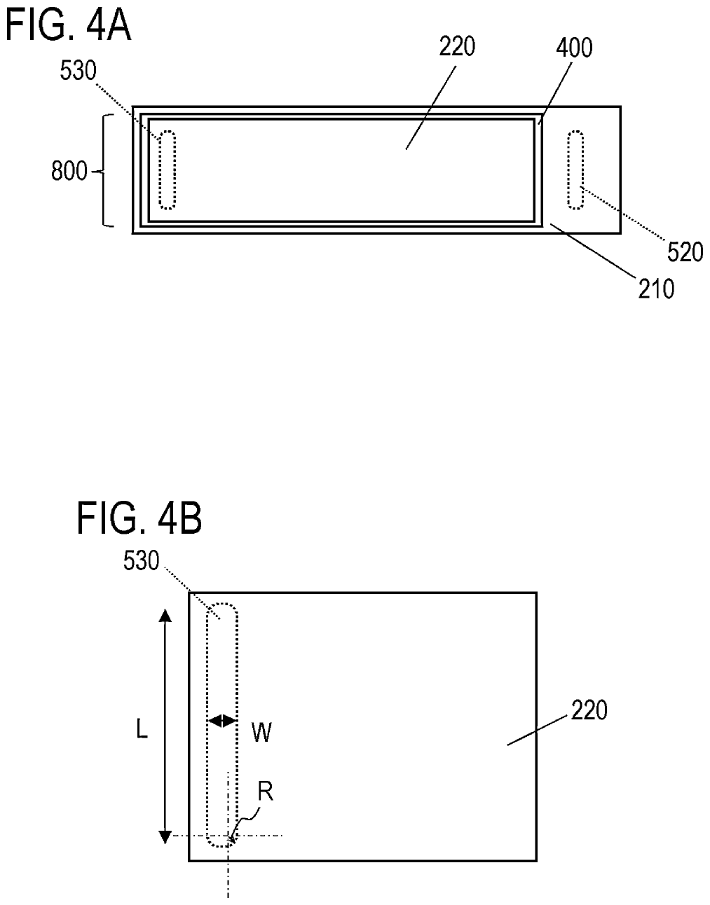

FIG. 4A is a schematic diagram depicting planar shapes of the upper through hole 530 and the lower through hole 520, and FIG. 4B is an enlarged view of the upper through hole 530 as an example. In the upper through hole 530 of Example 1, the length L in the lateral direction of the piezoelectric film 400 is 50 μm, the width W in the longitudinal direction of the piezoelectric film 400 is 5 μm, and the radius of curvature R of the corner portion is 1 μm.

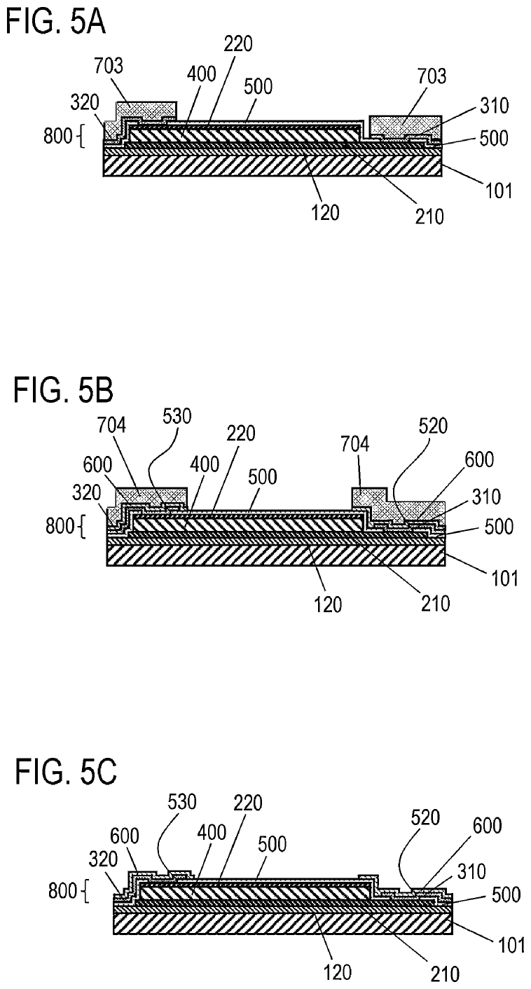

Now as a continuation of FIG. 3D, description of the actuator of this example is resumed with reference to FIG. 5A and the like. As illustrated in FIG. 5A, the films of the lower wiring 310 and the upper wiring 320 are formed by the sputtering method, and a resist pattern 703 is formed by the photolithography method such that the lower wiring 310 and the upper wiring 320 becomes desired patterns, and thereafter the respective wirings are formed by etching.

Then, as illustrated in FIG. 5B, a silicon nitride film 600 of a 50 nm thickness is deposited by the CVD method on the wirings as a passivation film having high insulating properties, and a resist pattern 704 is formed by the photolithography method so as to become a desired pattern, and thereafter the passivation film is opened by etching.

By this etching, the openings of the silicon nitride film 600 (passivation film) on the actuator 800 and on the electrode terminal portions (not illustrated), to which voltage for driving the actuator is applied, and which are disposed at the respective wiring edges connected to the lower electrode 210 and the upper electrode 220, may be carried out simultaneously.

On the actuator 800, the passivation film 600 is etched and the insulating film 500 is exposed; and on the electrode terminal portions (not illustrated) to which voltage for driving the actuator is applied, the passivation film 600 is etched and the electrode terminals are exposed. Thereby the actuator according to Example 1, illustrated in FIG. 5C, is completed.

Finally a second substrate, which includes a liquid supply portion, a liquid ejection nozzle portion, and the like (and in some cases, a third substrate) are provided and bonded with the substrate on which the actuator was formed, whereby the liquid ejection head is fabricated. Then by mounting and assembling this liquid ejection head with electronic components, support members and the like, just like the case of manufacturing conventional liquid ejection heads, a liquid ejection head unit is completed.

### Example 2

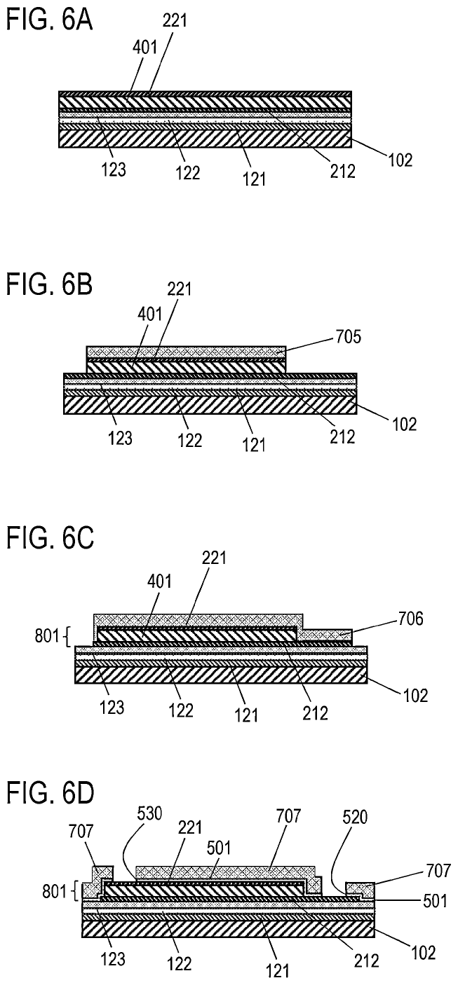

Example 2 will be described with reference to the drawings. FIGS. 6A to 8C are schematic diagrams of an example of the actuator and a manufacturing method thereof according to Example 2. As illustrated in FIG. 6A, a substrate 102 formed of silicon monocrystals is provided, and a silicon oxide film of about a 1 μm thickness is deposited by the wet oxidation method, which forms the oxide film using O₂ and H₂ gas, and an insulating film 121 is formed thereby.

Then a polysilicon film 122 of about a 2 μm thickness is deposited by the CVD method, and further a silicon oxide film 123 of about a 1 μm thickness is deposited by the wet oxidation method which forms an oxide film using O₂ and H₂ gas.

Then a lower electrode 212 is formed by laminating titanium as an adhesion layer (not illustrated) and platinum thereon by the sputtering method, and a piezoelectric film 401 is formed by lead zirconate titanate by the sol-gel method, and is then baked at 800° C. to have a desired crystal orientation, and an upper electrode 221 is formed of tungsten by the sputtering method.

Then, as illustrated in FIG. 6B, a resist pattern 705 is formed by the photolithography method, such that the upper electrode 221 and the piezoelectric film 401 have desired patterns, and thereafter the upper electrode 221 and the piezoelectric film 401 are etched.

Then, as illustrated in FIG. 6C, a resist pattern 706 is formed by the photolithography method again, such that the lower electrode 212 has a desired pattern, and thereafter the lower electrode 212 is etched, and an actuator 801, constituted of the lower electrode 212, the piezoelectric film 401 and the upper electrode 221, is formed.

Then, as illustrated in FIG. 6D, an insulating film 501 of about a 600 nm thickness is formed on the actuator 801 by the CVD method. Then a resist pattern 707 is formed on the insulating film 501 to have a predetermined pattern by the photolithography method, so that a through hole is formed in the upper electrode 221 and the lower electrode 212, and thereafter the upper through hole 530 and the lower through hole 520 are formed by etching.

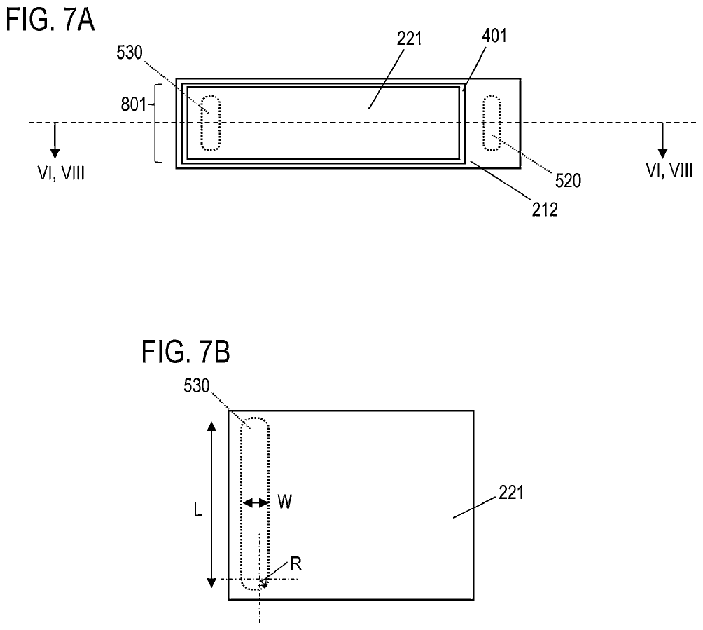

FIG. 7A is a schematic diagram depicting planar shapes of the upper though hole 530 and the lower through hole 520, and FIG. 7B is an enlarged view of the upper through hole 530 as an example. In the upper through hole 530 of Example 2, the length L in the lateral direction of the piezoelectric film 401 is 80 μm, the width W in the longitudinal direction of the piezoelectric film 401 is 12 μm, and the radius of curvature R of the corner portion is 5 μm.

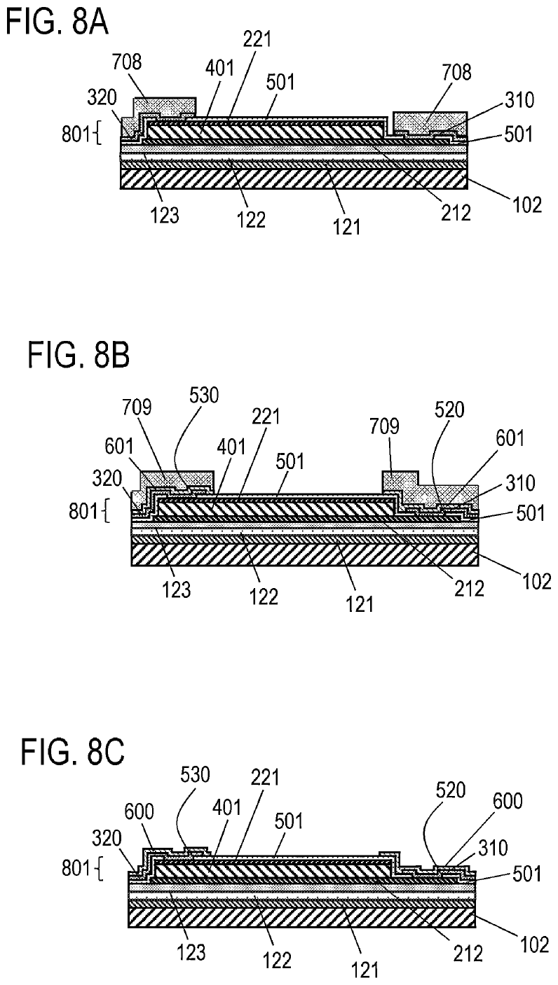

Now, as a continuation of FIG. 6D, description of the actuator of this example is resumed with reference to FIG. 8A and the like. As illustrated in FIG. 8A, the films of the lower wiring 310 and an upper wiring 320 are formed of an aluminum alloy by the sputtering method, and a resist pattern 708 are formed by the photolithography method such that the lower wiring 310 and the upper wiring 320 have desired patterns, and thereafter the respective wirings are formed by etching.

Then, as illustrated in FIG. 8B, a silicon nitride film 601 of a 300 nm thickness is deposited by the CVD method on the wirings as a passivation film having high insulating properties, and a resist pattern 709 is formed by the photolithography method so as to become a desired pattern, and thereafter the passivation film is opened by etching.

By this etching, the openings of the silicon nitride film 601 (passivation film) on the actuator 801 and on the electrode terminal portions (not illustrated), to which voltage for driving the actuator is applied and which are disposed at the respective wiring edges connected to the lower electrode 212 and the upper electrode 221, may be carried out simultaneously.

On the actuator 801, the passivation film 601 is etched and the insulating film 501 is exposed; and on the electrode terminal portions (not illustrated) to which voltage for driving the actuator is applied, the passivation film 601 is etched and the electrode terminals are exposed. Thereby the actuator according to Example 2, illustrated in FIG. 8C, is completed.

Finally a second substrate, which includes a liquid supply portion, a liquid ejection nozzle portion, and the like (and in some cases, a third substrate) are provided and bonded with the substrate on which the actuator was formed, whereby the liquid ejection head is fabricated. Then by mounting and assembling this liquid ejection head with electric components, support member, and the like, just like the case of manufacturing conventional liquid ejection heads, a liquid ejection head unit is completed.

### Example 3

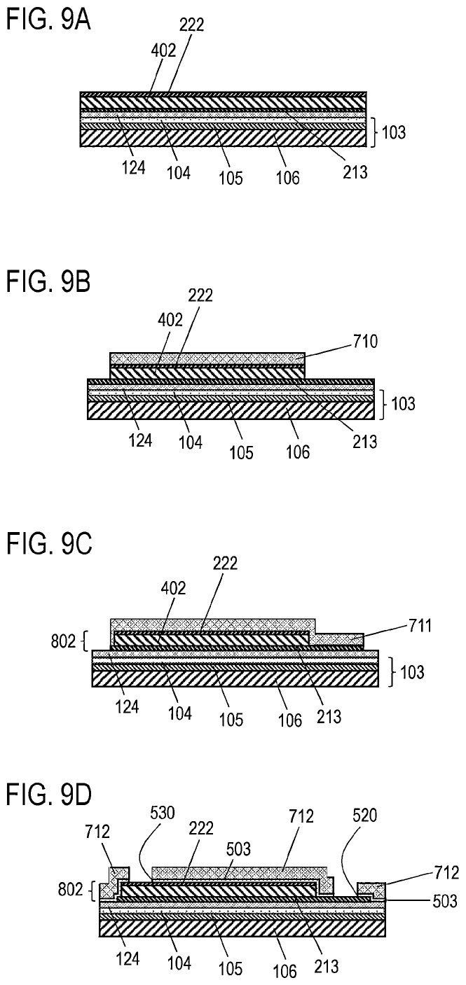

Example 3 will be described with reference to the drawings. FIGS. 9A to 11C are schematic diagrams of an example of the actuator and a manufacturing method thereof according to Example 3.

As illustrated in FIG. 9A, an SOI substrate 103 is provided. The SOI substrate 103 is constituted of a silicon monocrystal layer 104, which is the top layer on the surface of the substrate, a silicon oxide film 105, which is an insulating film commonly called a BOX layer disposed thereunder, and a support substrate 106. Then, on the surface of the silicon layer 104, a silicon oxide film of about a 0.8 μm thickness is formed by the wet oxidation method, which forms an oxide film using O₂ and H₂ gas, and an insulating film 124 is formed thereby.

Then a lower electrode 213 is formed by laminating titanium as an adhesion layer (not illustrated) and platinum thereon by the sputtering method, and a piezoelectric film 402 is formed of lead zirconate titanate by the sputtering method, and is then baked at 700° C. to have a desired crystal orientation, and an upper electrode 222 is formed of a tungsten titanate alloy by the sputtering method.

Then, as illustrated in FIG. 9B, a resist pattern 710 is formed by the photolithography method, such that the upper electrode 222 and the piezoelectric film 402 have desired patterns, and thereafter the upper electrode 222 and the piezoelectric film 402 are etched.

Then, as illustrated in FIG. 9C, a resist pattern 711 is formed by the photolithography method again, such that the lower electrode 213 has a desired pattern, and thereafter the lower electrode 213 is etched, and an actuator 802, constituted of the lower electrode 213, the piezoelectric film 402 and the upper electrode 222, is formed.

Then, as illustrated in FIG. 9D, an alumina film 502 (not illustrated) of about a 10 nm thickness is formed on the actuator 802 by the atomic layer deposition (ALD) method, and further an insulating film 503 of 400 nm thickness is formed thereon by the CVD method. Then a resist pattern 712 is formed on the insulating film 503 to have a predetermined pattern by the photolithography method, so that a through hole is formed in the upper electrode 222 and the lower electrode 213. Thereafter, the upper through hole 530 and the lower through hole 520 are formed by etching the insulating film 503 and the alumina film 502 simultaneously.

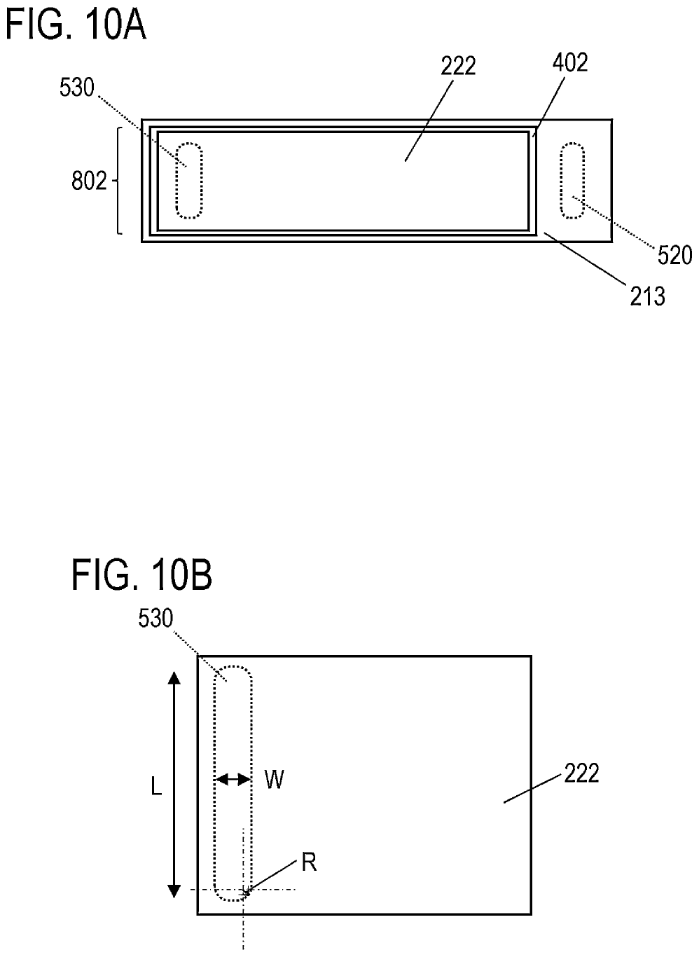

FIG. 10A is a schematic diagram depicting planar shapes of the upper through hole 530 and the lower through hole 520, and FIG. 10B is an enlarged view of the upper through hole 530 as an example. In the upper through hole 530 of Example 3, the length L in the lateral direction of the piezoelectric film 402 is 100 μm, the width W in the longitudinal direction of the piezoelectric film 402 is 10 μm, and the radius of curvature R of the corner portion is 4 μm.

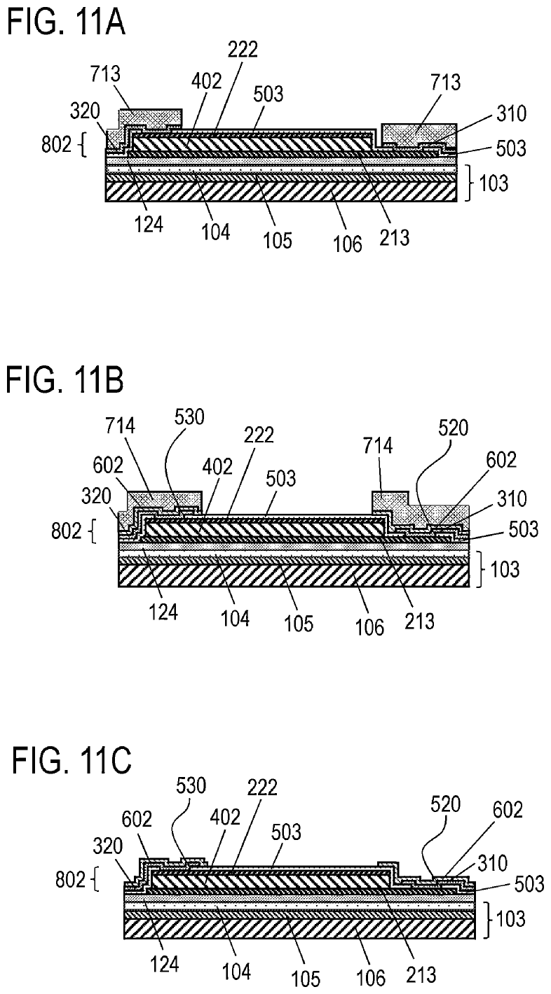

Now, as a continuation of FIG. 9D, description of the actuator of this example is resumed with reference to FIG. 11A and the like. As illustrated in FIG. 11A, the films of the lower wiring 310 and the upper wiring 320 are formed by laminating a titanium ally and an aluminum alloy in sequence by the sputtering method, and a resist pattern 713 is formed by the photolithography method such that the lower wiring 310 and the upper wiring 320 have desired patterns, and thereafter the respective wirings are formed by etching the laminated film of the titanium alloy and the aluminum alloy.

Then, as illustrated in FIG. 11B, a silicon nitride film 602 of a 400 nm thickness is deposited by the CVD method on the wirings as a passivation film having high insulating properties, and a resist pattern 714 is formed by the photolithography method so as to become a desired pattern, and thereafter the passivation film is opened by etching.

By this etching, the openings of the silicon nitride film 602 (passivation film) on the actuator 802 and on the electrode terminal portions (not illustrated), to which voltage for driving the actuator is applied, and which are disposed at the respective wiring edges connected to the lower electrode 213 and the upper electrode 222, may be carried out simultaneously.

On the actuator 802, the passivation film 602 is etched and the insulating film 503 is exposed; and on the electrode terminal portions (not illustrated) to which voltage for driving the actuator is applied, the passivation film 602 is etched and the electrode terminals are exposed. Thereby the actuator according to Example 3, illustrated in FIG. 11C, is completed.

Finally a second substrate, which includes a liquid supply portion, a liquid ejection nozzle portion, and the like (and in some cases, a third substrate) are provided and bonded with the substrate on which the actuator was formed, whereby the liquid ejection head is fabricated. Then by mounting and assembling this liquid ejection head with electric components, support members and the like, just like the case of manufacturing conventional liquid ejection heads, a liquid ejection head unit is completed.

Thus for an actuator, where the through hole is formed on both sides of the piezoelectric film in the longitudinal direction, has been described, but the present disclosure is not limited to this. In other words, the through hole may be disposed only on one side of the photoelectric film in the longitudinal direction. For example, only the upper through hole may be formed without forming the lower through hole, and the lower electrode and the lower wiring may be integrated as a same member.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-176937, filed on Oct. 12, 2023, which is hereby incorporated by reference herein in its entirety.

What is claimed is:

1. An actuator for a liquid ejection head, the actuator comprising:
an electrode which is disposed on a substrate;
a piezoelectric film which is configured to be displaced by application of voltage from the electrode;
a wiring which is electrically connected to the electrode;
a first insulating film, which is disposed to be interposed between the electrode and the wiring, and which has a through hole for electrically connecting the electrode and the wiring; and
a second insulating film which covers the wiring,
wherein the through hole has a planar shape including a curved portion, in a view in a thickness direction of the substrate, and
wherein a radius of curvature of the curved portion is at least 8 times a film thickness of the first insulating film.

2. The actuator according to claim 1, wherein
the film thickness of the first insulating film is at least 30 nm (nanometers).

3. The actuator according to claim 1, wherein
the planar shape is a rounded rectangle, in the view in the thickness direction of the substrate.

4. The actuator according to claim 3, wherein
a width of the rounded rectangle of the through hole in a lateral direction is at least 2 times the radius of curvature.

5. The actuator according to claim 3, wherein
a width of the rounded rectangle of the through hole in a lateral direction is at least 480 nm (nanometers).

6. The actuator according to claim 1, wherein
the through hole is formed at least on either one side or the other side of the piezoelectric film in a longitudinal direction of the piezoelectric film.

7. The actuator according to claim 1,
wherein the electrode includes a first electrode which is disposed between the piezoelectric film and the substrate, and a second electrode which is disposed on an opposite side of the piezoelectric film to the first electrode,
wherein the wiring includes a first wiring which is electrically connected to the first electrode, and a second wiring which is electrically connected to the second electrode, and
wherein the through hole includes a first through hole for electrically connecting the first electrode and the first wiring, and a second through hole for electrically connecting the second electrode and the second wiring.

8. The actuator according to claim 7, wherein
the first through hole and the second through hole are formed on one side and the other side of the piezoelectric film in a longitudinal direction of the piezoelectric film respectively, and the first electrode contains platinum and the second electrode contains titanium or tungsten.

9. The actuator according to claim 8, wherein
the through hole is formed to be linearly symmetrical with respect to a center line passing through the center of the piezoelectric film in a lateral direction of the piezoelectric film.

10. A liquid ejection head configured to eject liquid, by driving an actuator, the actuator comprising:
an electrode which is disposed on a substrate;
a piezoelectric film which is configured to be displaced by application of voltage from the electrode;
a wiring which is electrically connected to the electrode,
a first insulating film, which is disposed to be interposed between the electrode and the wiring, and which has a through hole for electrically connecting the electrode and the wiring; and
a second insulating film which covers the wiring,
wherein the through hole has a planar shape including a curved portion, in a view in a thickness direction of the substrate, and
wherein a radius of curvature of the curved portion is at least 8 times a film thickness of the first insulating film.

11. A liquid ejection apparatus comprising a liquid ejection head configured to eject liquid by driving an actuator,
wherein the actuator comprises:
an electrode which is disposed on a substrate;
a piezoelectric film which is configured to be displaced by application of voltage from the electrode;
a wiring which is electrically connected to the electrode;
a first insulating film, which is disposed to be interposed between the electrode and the wiring, and which has a through hole for electrically connecting the electrode and the wiring; and
a second insulating film which covers the wiring,
wherein the through hole has a planar shape including a curved portion, in a view in a thickness direction of the substrate, and
wherein a radius of curvature of the curved portion is at least 8 times a film thickness of the first insulating film.
